(19) United States
(12) Patent Application Publication
(10) Pub. No.: US 2019/0100252 A1
(43) Pub. Date: Apr. 4, 2019

(54) METHOD AND PRESS TOOL FOR THE PRODUCTION OF A HYBRID VEHICLE STRUCTURE, AND HYBRID VEHICLE STRUCTURE

(71) Applicant: Benteler Automobiltechnik GmbH, Paderborn (DE)

(72) Inventors: Alexander Boettcher, Paderborn (DE); Günter Fortmeier, Delbrück (DE); Frank Höcker, Ibbenbüren (DE); Matthias Körner, Schloss Holte-Stukenbrock (DE)

(73) Assignee: Benteler Automobiltechnik GmbH, Paderborn (DE)

(21) Appl. No.: 16/140,219

(22) Filed: Sep. 24, 2018

(30) Foreign Application Priority Data
Sep. 29, 2017 (DE) 10 2017 122 670.2

(51) Int. Cl. B62D 29/00; B29C 43/18; B29C 70/46; B29C 70/54; B29C 70/78

(52) U.S. Cl. CPC B62D 29/005; B29C 43/183; B29K 2705/00; B29C 70/541; B29C 70/78; B29C 70/46

(57) ABSTRACT

In a method of producing a hybrid structure, a fiber material is formed three-dimensionally during a pressing process through extrusion in a press tool to produce a functional component. The fiber material is hardened at least in part and directly joined in the press tool with a metal component. Forming of the functional component of fiber-reinforced plastic and joining with the metal component is implemented in a single method step.

### CROSS-REFERENCES TO RELATED APPLICATIONS

This application claims the priority of German Patent Application, Serial No. 10 2017 122 670.2, filed Sep. 29, 2017, pursuant to 35 U.S.C. 119(a)-(d), the disclosure of which is incorporated herein by reference in its entirety as if fully set forth herein.

### BACKGROUND OF THE INVENTION

The present invention relates to a method and press tool for the production of a hybrid vehicle structure, and to a hybrid vehicle structure.

The following discussion of related art is provided to assist the reader in understanding the advantages of the invention, and is not to be construed as an admission that this related art is prior art to this invention.

Metallic materials, in particular steel and aluminum, are commonly used in the automobile construction. Increasingly the use of vehicle components of fiber-reinforced plastics (FRP) finds application because of their weight benefits. As a consequence of weight saving, CO₂ emission and environmental pollution can be reduced. Synergy effects of metallic materials and fiber-reinforced materials can be realized by fabricating hybrid structures. Thus, vehicle structures, especially body parts and/or chassis parts, are increasingly produced through hybrid construction, involving a reinforcement of regions of metallic base bodies or metal components with a fiber-reinforced composite material to thereby produce lightweight structures with better crash behavior. In addition, efforts are underway to produce vehicle structures as cost-effective as possible. All approaches to date are, however, complex and inadequate.

It would therefore be desirable and advantageous to address prior art shortcomings.

### SUMMARY OF THE INVENTION

According to one aspect of the present invention, a method of producing a hybrid structure includes forming a fiber material three-dimensionally during a pressing process through extrusion in a press tool to produce a functional component, hardening the fiber material at least in part, and directly joining the fiber material in the press tool with a metal component.

In accordance with the present invention, a hybrid structure, in particular a hybrid vehicle structure, includes a metal component and a functional component of fiber-reinforced plastic. The metal component is made advantageously of steel or light metal, in particular of aluminum or an aluminum alloy. The hybrid structure is produced by joining the metal component and a fiber material, in particular a fiber material that is pre-impregnated by a thermoplastic matrix, in a press tool. For this purpose, the metal component and the fiber material are transferred into the press tool, positioned in relation to one another, and connected together in a pressing process under temperature and pressure. During the pressing process, the fiber material is formed through extrusion three-dimensionally into the functional component, hardened at least in part, and directly joined with the metal component, i.e. there is a direct contact between the functional component and the metal component. The metal component can be coated, e.g. by cathodic electro-deposition, lacquer, or an adhesion promoter.

Formation, in particular the final formation of the functional component is realized in accordance with the present invention in a same process step as the joining of the functional component with the metal component. Extrusion and joining of the fiber-reinforced plastic or the fiber material are thus integrated in one method step.

The fiber material is formed under pressure in the press tool. During this process, a pressure is generated which is high enough to form the heated fiber material as well as directly joining the fiber material with the metal component. Formation of the functional component and joining with the metal component are implemented simultaneously during a pressing process. As the metal component and the fiber composite plastic structure are joined, a force fit, form fit and/or material joint is/are established between the functional component and the metal component.

The term “functional component” within the scope of the present invention relates to a component that assumes in particular a stiffening and/or reinforcing function in a hybrid vehicle structure.

According to another advantageous feature of the present invention, the fiber material can be configured as a stack of, e.g. plies of pre-impregnated fiber material. Of course, other types of fiber material may equally find application, such as, e.g. fiber material that is plastic or resin impregnated or contain plastic or resin deposits. Resin may also be supplied or injected from outside during the pressing process. The plies of fiber material are stacked upon one another and may involve short fiber mats and/or long fiber mats that can be resin-impregnated, advantageously on the basis of thermoplastic material.

According to another advantageous feature of the present invention, the fiber-reinforced plastic may include at least one fiber selected from the group consisting of natural fiber, plastic fiber, glass fiber, aramid fiber, polypropylene fiber, polyamide fiber, metal fiber, and mineral fiber, e.g. carbon fiber or basalt fiber.

The fiber material or fibers of fiber material may be arranged as fabric or mat uniaxially or multiaxially or quasi-isotropically as randomly oriented fibers. Mixtures of fibers of varying lengths may be used as fiber material as well.

According to another advantageous feature of the present invention, the metal component can be configured as a shell-shaped metal structure or U shaped cross section, defining a base web and two side legs respectively connected to the base web. The functional component may be arranged in particular on the inside of the shell-shaped metal component, with the functional component extending transversely between the side legs.

According to another advantageous feature of the present invention, the functional component of fiber-reinforced plastic can be joined with the base web and/or the side legs.

A metal component for the production of a hybrid functional component may involve a flat sheet, a pre-shaped molded part (parison) or already formed or end-formed metal component. The metal component may also involve a cast part.

According to another advantageous feature of the present invention, a flat metal sheet or a metallic molded part can be pressed during the pressing process into the final form. The metal sheet or metal component is formed and end-formed together with the fiber material and both material partners are directly joined with one another.

A prefabricated or end-formed metal component may be configured in particular shell-shaped.

According to another advantageous feature of the present invention, the metal component can have at least one region with a structured surface. The metal surface may be structured mechanically, e.g. by stamping, brushing, or grinding, or by chemical treatment or thermal treatment. Structuring of the surface may be realized on a blank of the metal component, or parison, or on the finally formed metal component. A metal surface that is structured as described above improves an adhesion effect between metal surface and joined functional component of fiber-reinforced plastic. This augments structural stiffness of the hybrid structures. The structured surface includes in particular a hooked structure, Velcro structure and/or claw structure.

According to another advantageous feature of the present invention, an adhesion promoter can be applied upon at least one region of the metal component and/or the fiber material prior to the pressing process. As a result, the bond between the metal component and the functional component in the joint area can be improved. Advantageously, the adhesion promoter is applied upon an upper facing of the fiber material. The adhesion promoter may be an adhesive, e.g. a two-component adhesive. Also, a thermal adhesion promoter and/or other adhesive systems may find application.

During forming, the fiber material can be maintained under moderate temperature. The metal component can be heated at least in part. This is implemented prior to the pressing process. Thereafter, the heated metal component is placed into the press tool. The fiber material can be heated to maintain it under moderate temperature prior to and/or during and/or after the pressing process. The fiber material may also be heated within the press tool prior to, during, or after closing of the press tool.

According to another advantageous feature of the present invention, at least one region of the metal component can be provided prior to the pressing process with a covering, mask, or coating. As a result, covered surface regions can be protected during the pressing process and therefore are not provided with the plastic matrix.

According to another advantageous feature of the present invention, a layer of fiber-reinforced plastic can be applied upon a surface of the metal component in a region adjacent to the functional component. The layer may involve a thin, skin-like layer of a thickness between 0.2 mm and 2.00 mm as practical tests have shown.

According to another aspect of the present invention, a press tool for the production of a hybrid structure includes first and second tool parts, e.g. an upper tool and a lower tool. The first tool part has a receptacle shaped to match an outer contour of a metal component. The second tool part is configured to receive the fiber material. The press tool has a cavity for forming a functional component of fiber-reinforced plastic by way of extrusion of the fiber material during the pressing process. At the same time, the cavity is configured to directly join the functional component with the metal component during extrusion. Advantageously, the cavity is provided in the second tool part or lower tool.

The first and second tool parts can be moved in relation to one another and/or moved together.

According to another advantageous feature of the present invention, the press tool can include a ram which can be moved in relation to the cavity and/or in relation to the first and/or second tool part. Advantageously, the cavity in the second tool part or lower tool may be configured in the shape of a recess. A ram in the form of a moving center piece can be placed from below into the cavity

A press tool can have several receptacles, cavities and/or rams and may be configured such that several functional components can directly be joined with a metal component during a press stroke. During the pressing process, the metal component may be formed simultaneously and pressed into its final form.

The fiber material can be positioned in the second tool part in the area of the cavity in or upon the receptacle. The second tool part can include adjacent to the cavity a support contour which matches the inner contour of the metal component.

After introducing the fiber material, the metal component is positioned upon the second tool part. The metal component may hereby be secured by suitable restraining elements which may also properly position the metal component during the pressing process. The press tool is then closed by moving the first tool part (upper tool) in relation to the lower tool. Both upper and lower tools of the press tool come into contact. At least one region of the metal component can bear with its outer contour in the receptacle of the upper tool. After the upper and lower tools come into contact and the press tool is closed, both the upper and lower tools jointly move in a direction of the stroke and move in relation to the ram that is integrated in the cavity. After conclusion of the stroke movement by the upper and lower tools or at the same time, the ram is moved in opposition to the stroke movement and the fiber material is extruded and formed under pressure into a three-dimensional end contour. At the same time, the thus-produced functional component is directly joined with the metal component, with a force fit and/or form fit and/or material joint being established between the metal component and the functional component. The join or connection between the metal component and the functional component may be assisted by an adhesion promoter, such as glue, or by a structuring of the surface of the metal component in the joining zone.

A hybrid structure according to the present invention can be fabricated also with the use of a planar metal sheet which is formed together with the fiber material during the pressing process into a final shape. The metal sheet is formed in the receptacle of the upper tool of the press tool. At the same time, the fiber material is pressed and joined, the functional component is formed, and the direct connection with the metal component is implemented.

An alternative approach for the production of a hybrid vehicle structure according to the present invention involves the use of a press tool in the absence of a separately moving ram. The press tool has a lower tool in which the cavity is provided such as to have a contour which matches the shape of a functional component to be fabricated. The relief of the cavity is inverted to the three-dimensional contour of the functional component. The fiber material, for example a stack of fiber material plies comprised of short fiber mats or long fiber mats in stack formation is placed in the region of the cavity. The upper and lower tools of the press are then closed. The fiber material is plasticized and extruded in the cavity. At the same time, part of the fiber composite plastic is displaced from the region of the cavity and dispersed at least in part adjacent to the joining region between the functional component and the metal component across the metal surface. As a result, a very thin skin-like fiber-reinforced plastic layer is obtained.

Also this procedure may involve application of an adhesion promoter upon the surface of the metal component. The adhesion promoter may hereby be applied across the entire surface of the metal component or over at least a region thereof.

According to another aspect of the present invention, a hybrid structure includes a metal component, and a functional component which is formed through extrusion from fiber material and directly joined with the metal component during extrusion. The functional component is extruded from fiber material, e.g. a stack of fiber material plies and both formed and directly joined with the metal component in a press tool during the extrusion process, A hybrid structure according to the present invention can be produced effectively, with optimized weight and can be exposed to high stress both dynamically and statically. The functional component may hereby be joined to the metal component at a location that is dimensioned to resist stress.

According to another advantageous feature of the present invention, the metal component can have a shell-shaped or U shaped cross section, defining a base web and two side legs which are respectively connected to the base web, with the functional component extending transversely between the side legs. The functional component may be configured wall-like in the form of a rib or a bulkhead between the side legs. A functional component in the form of a bulkhead extends as a wall between the side legs. The functional component may also be configured like a framework.

According to another advantageous feature of the present invention, the functional component can be joined with the base web and/or the side legs.

Advantageously, the functional component is directly joined with the metal component across the entire contact area. During extrusion, the fiber material is formed three-dimensionally to match the contour of the metal component in the joining region. As a result of its rib-shaped configuration and/or configuration in the form of a bulkhead, the functional component is able to assume reinforcement and stiffening functions.

According to still another aspect of the present invention, a motor vehicle includes a hybrid structure which includes a metal component, and a functional component which is formed through extrusion from fiber material and directly joined with the metal component during extrusion. A motor vehicle fabricated in this manner is improved in terms of weight. The configuration and use of hybrid vehicle structures results in improved stress resistance and weight reduction. The afore-described cost-effective and efficient fabrication of hybrid vehicle structures reduces costs of motor vehicles.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a perspective view of a lower tool of a press tool for use in the production of a first embodiment of a hybrid vehicle structure in accordance with the present invention;

FIG. 1b is a perspective view of the lower tool, with illustration of a ram;

FIGS. 1c and 1d are perspective views of method steps for the production of the hybrid vehicle structure in accordance with the present invention;

FIG. 1e is a schematic illustration of the press tool with lower tool and upper tool;

FIG. 1f is a schematic illustration of the press tool in a closed state;

FIG. 1g is a perspective view of the hybrid vehicle structure, as viewed obliquely from below;

FIG. 2 is a simplified and schematic illustration of a press tool for use in the production of a second embodiment of a hybrid vehicle structure in accordance with the present invention;

FIG. 3 is a schematic illustration of a detail of a metal component, depicting a structured surface; and

FIG. 4 is a schematic illustration of a detail of a metal component, depicting another variant of a structured surface of a metal component.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

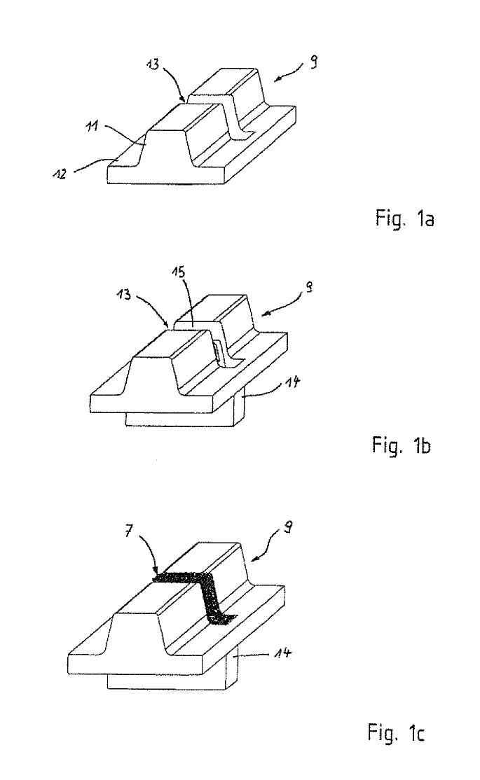

Turning now to the drawing, and in particular to FIG. 1a, there is shown a perspective view of a lower tool, generally designated by reference numeral 9, of a press tool, generally designated by reference numeral 2 and illustrated in particular in FIG. 1e, for use in the production of a first embodiment of a hybrid vehicle structure in accordance with the present invention. A hybrid structure or hybrid vehicle structure, generally designated by reference numeral 1, is shown in greater detail in FIG. 1g which is a perspective view obliquely from below.

As shown in FIG. 1g, the hybrid structure 1 includes a shell-shaped metal component 3 and a functional component 4 which is made of fiber-reinforced plastic, e.g. a glass fiber reinforced thermoplastic material, and joined with the metal component 3. The metal component 3 is made of steel material or light metal material. The metal component 3 is configured U shaped in cross section and includes a base web 5 and two side legs 6. The functional component 4 extends transversely between the side legs 6. The functional component 4 is joined with the base web 5 and the side legs 6 across the entire contact area between the metal component 3, and the functional component 4 provides stiffening and reinforcement of the hybrid structure 1. The functional component 4 is formed by extrusion from fiber material 7 and directly joined with the metal component 3 during the extrusion process. In the illustrated non-limiting example, the fiber material 7 is provided in the form of a stack of fiber material plies.

An exemplified embodiment of the press tool 2 is shown in FIG. 1e and includes a first tool part in the form of an upper tool 8 and a second tool part in the form of the lower tool 9. The upper tool 8 includes a receptacle 10 for the metal component 3. The receptacle 10 has a contour which matches an outer contour of the metal component 3. The lower tool 9 includes a support body 11 (FIG. 1a) of a configuration which complements an inner contour of the metal component 3. Extending on both sides of the support body 11 are outwardly directed flanges 12 (FIG. 1 a). The lower tool 9 has a recess 13 in which a ram 14, shown in FIG. 1b, is movably arranged, with the recess 13 and the ram 14 forming a cavity 15.

With reference to FIGS. 1c and 1d, the fabrication of the hybrid structure 1 will now be described in greater detail. The fiber material of fiber material plies is placed within the cavity 15 above the ram 14 into the recess 13 (FIG. 1c). The metal component 3 is then placed on top (FIG. 1d). The metal component 3 may be provided with adhesion promoter, in particular glue, across the entire surface or also in at least one region. The metal component 3 may also have a structured surface, at least in the area in which the functional component should be attached.

After the fiber material and the metal component 3 are united and positioned in the press tool 2 upon the lower tool 9, the press tool 2 is closed. The upper tool 8 moves hereby downwards, as indicated by arrow P1. Air may escape through vents. When the upper tool 8 touches the lower tool 9, both the upper and lower tools 8, 9 continue to move together downwards, as indicated by arrows P1 and P2. During this stroke movement, the metal component 3 is held in place by restraining elements 16. The upper tool 8 and the lower tool 9 move during the downward stroke movement in opposition to the force of spring elements 17 which are arranged below the restraining elements 16 (FIG. 1e). Thereafter, the ram 14 moves in opposite direction upwards, as indicated by arrow P3. As a result of the high pressure and temperature influence, the fiber material 7 is formed by an extrusion process three-dimensionally into the functional component 4 and directly joined with the metal component 3 at the same time. During extrusion, the functional component 4 undergoes at least partial hardening. The forming operation requires heating. For this purpose, the metal component 3 is heated at least in part prior to the pressing process. When the hybrid structure 1 is produced immediately after the metal component 3 undergoes hot forming, any residual heat of the formed metal component can be utilized for the extrusion process. It is also conceivable to heat the fiber material 7 prior to its placement into the press tool 2. Further, the press tool 2 can be heated prior to, during, or after closing of the press tool 2.

FIG. 1f shows the press tool 2 in the closed state, with the ram 14 having moved upwards. The stack of fiber material 7 of fiber reinforced plastic (FRP) is formed three-dimensionally into the functional component 4 and joined with the metal component 3. A material joint is hereby established. When the metal component 3 has structured surfaces, a form fit and force fit are additionally established.

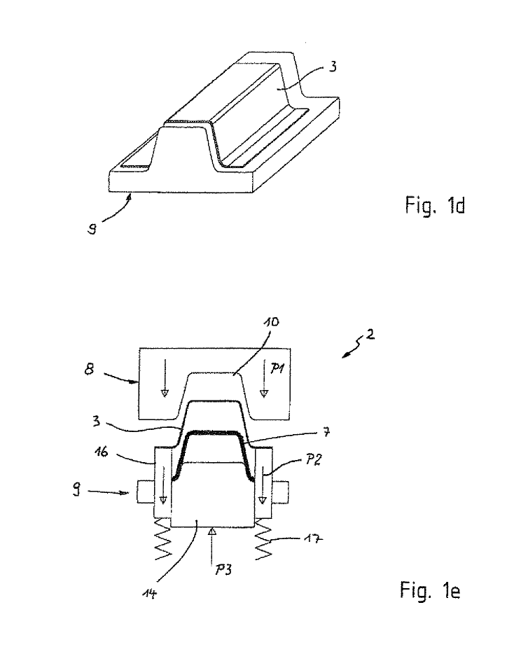

Turning now to FIG. 2, there is shown a simplified and schematic illustration of a press tool, generally designated by reference numeral 19, for use in the production of a second embodiment of a hybrid vehicle structure in accordance with the present invention, generally designated by reference numeral 18. The press tool 19 includes a first tool part in the form of an upper tool 20 and a second tool part in the form of a lower tool 21. A cavity 22 is provided in the lower tool 21 and has a contour which matches an outer contour of a functional component 23 to be produced. In the illustrated non-limiting example, a hollow shape is involved for the production of a rib-shaped or wall-shaped functional component 23.

A fiber material (not shown), e.g. a stack of fiber material mats (short fiber mats or long fiber mats) is positioned upon the lower tool 21 in the area of the cavity 22, and a metal component 23 is then placed upon the lower tool 21. The fiber material is trapped between the lower tool 21 and the inner contour of the metal component 24. Subsequently, the press tool 19 is closed. Under the influence of temperature and high pressure during closing of the press tool 19, the fiber material is shaped by pressure and extruded. The fiber material is hereby formed three-dimensionally in the cavity 21 through extrusion into the functional component 23 and directly joined with the metal component 24 as well as hardened entirely or in part. At the same time, fiber reinforced plastic is slightly displaced from the area of the cavity 22 and forms, at least in part, a thin skin-like layer 25 on the surface of the metal component 24.

In the mode of production described with reference to FIG. 2, the metal component 24 or the fiber material may be provided with an adhesion promoter prior to the pressing process at least in part. In addition, the metal component 24 may have a structured surface at least in the region of the joining surface. The stack can be heated prior to and/or during and/or after the pressing process. The metal component 24 may also be heated at least in part prior to the pressing process.

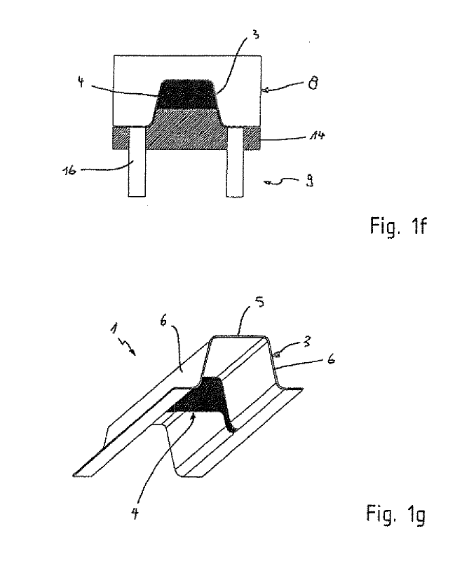

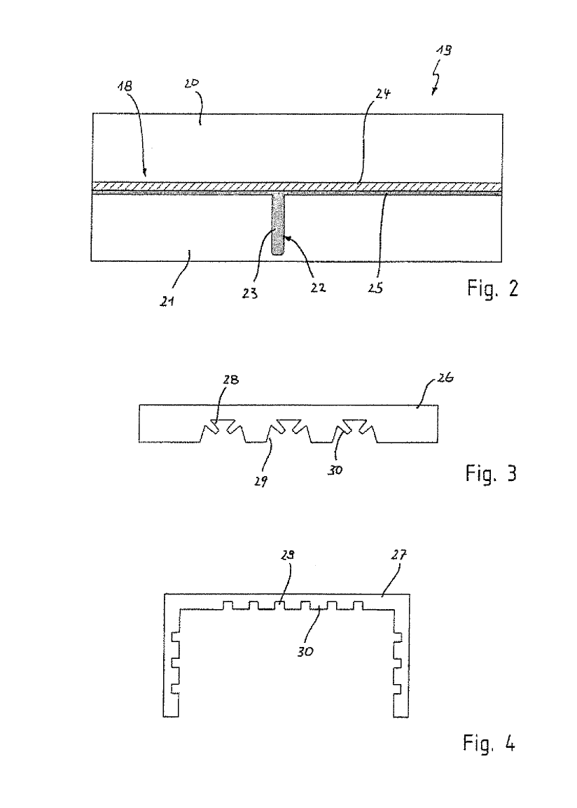

FIGS. 3 and 4 show schematic illustrations of possible structured surfaces of metal component, designated by reference numerals 26 and 27, respectively. Structuring may be realized through stamping or like mechanical processes, such as brushing or grinding. Also chemical treatment for producing a structured surface is conceivable. Advantageously, structuring of the surface is executed during production of the metal component 26, 27, for example as an additional process step in a forming device during cold forming. The structuring of the surface can be configured by undercuts 28, recesses 29 and ribs 30 as well as by scale-like stamping.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of producing a hybrid structure, comprising:
forming a fiber material three-dimensionally during a pressing process through extrusion in a press tool to produce a functional component;
hardening the fiber material at least in part; and
directly joining the fiber material in the press tool with a metal component.

2. The method of claim 1, wherein the metal component is a shell-shaped metal structure.

3. The method of claim 1, further comprising forming a metal sheet during the pressing process to the metal component.

4. The method of claim 1, further comprising forming the functional component during the pressing process to a shape of a rib or shape of a bulkhead.

5. The method of claim 1, further comprising structuring at least one region of a surface of the metal component.

6. The method of claim 1, further comprising applying an adhesion promoter upon at least one region of at least one of the metal component and the fiber material prior to the pressing process.

7. The method of claim 6, wherein the adhesion promoter is an adhesive.

8. The method of claim 1, further comprising at least partly heating the metal component prior to the pressing process.

9. The method of claim 1, further comprising heating the fiber material at least in one of the phases selected from the group consisting of prior to the pressing process, during the pressing process, and after the pressing process.

10. The method of claim 1, further comprising providing at least one region of the metal component prior to the pressing process with a covering, mask or coating.

11. The method of claim 1, further comprising forming a layer of fiber-reinforced plastic upon a surface of the metal component in a region adjacent to the functional component.

12. The method of claim 1, wherein the fiber-reinforced plastic includes at least one fiber selected from the group consisting of natural fiber, plastic fiber, glass fiber, aramid fiber, polypropylene fiber, polyamide fiber, metal fiber, and mineral fiber.

13. The method of claim 12, wherein the mineral fiber is carbon fiber or basalt fiber.

14. The method of claim 1, wherein the fiber material is configured as a stack of fiber material layers.

15. A hybrid structure, comprising:
a metal component; and
a functional component formed through extrusion from fiber material and directly joined with the metal component during extrusion.

16. The hybrid structure of claim 15, wherein the metal component has a U shaped cross section, defining a base web and two side legs respectively connected to the base web, said functional component extending transversely between the side legs.

17. The hybrid structure of claim 16, wherein the functional component is joined with at least one of the base web and the side legs.

18. A motor vehicle, comprising a hybrid structure which includes a metal component, and a functional component which is formed through extrusion from fiber material and directly joined with the metal component during extrusion.

19. The motor vehicle of claim 18, wherein the fiber material is formed three-dimensionally during extrusion and hardened at least in part.
